(19) United States
(12) Patent Application Publication
(10) Pub. No.: US 2003/0031393 A1
(43) Pub. Date: Feb. 13, 2003

(54) Bearing with tapered rolling bodies provided with a sealing device

(76) Inventor: Stephane Bellufi, Seynod (FR)

Correspondence Address: NAWROCKI, ROONEY & SEVERTSON, P.A., Broadway Place East, Suite 401, 3433 Broadway Street N.E., Minneapolis, MN, 55413, US

(21) Appl. No.: 10/195,690

(22) Filed: Jul. 12, 2002

(30) Foreign Application Priority Data
Jul. 13, 2001 (FR) 01 09418

(51) Int. Cl. F16C 33/76

(52) U.S. Cl. 384/486

(57) ABSTRACT

The invention relates to a roller bearing of the type comprising an outer race (1) and at least one inner race (2), the said races each comprising at least one oblique raceway (6) for tapered rolling bodies (4) disposed between them, in which an annular housing (12) is provided between the said races in order to receive a sealing device for the bearing, in which the sealing device comprises a dynamic sealing joint (16) associated with one of the races, the inside diameter of the joint (16) being greater than or equal to the large diameter (Dₑₓₜ) of the running surface of the raceway (6) of the outer race (1), and an annular frame (16) associated with the other race, the said frame (17) comprising an annular housing (18) in which the joint (17) is disposed so as to rub against the said frame during the relative rotation of the races (1, 2).

The invention relates to a roller bearing and a method for assembling such a bearing.

The bearings according to the invention are of the type with tapered rolling bodies, in particular with two rows of tapered rolling bodies, which provide the relative rotation of an outer race with respect to at least one inner race.

This type of bearing, through their suitability for withstanding high radial and axial forces, find application in particular in the rotation of a motor vehicle wheel with respect to the chassis of the said vehicle.

One of the problems which is posed is being able to ensure the dynamic sealing of such bearings.

There are known, for example from the document EP-0 458 123, sealing devices for ball bearings which comprise a sealing joint and a frame against which the joint rubs during rotation.

However, because of the mounting constraints specific to bearings with tapered rolling bodies, this type of sealing device cannot be used in such bearings. This is because, in bearings with tapered rolling bodies, the mounting of the outer race on the inner race is effected after the arrangement of the rolling bodies on the inner race, whereas, in the case of ball bearings, the rolling bodies are disposed in advance on the outer race.

In order to resolve this problem, the document EP-0 687 825 proposes to equip a bearing with tapered rolling bodies with a sealing device which comprises a lip in rubbing contact on one face of the inner race.

However, this solution, though it allows the mounting of the bearing, is not satisfactory from the point of view of reliability of the seal on the bearing.

This is because, the lip coming into contact directly on the inner race, the seal will depend on the surface finish of the contact area. However, the choice of the material forming the inner race and therefore its surface finish is limited by the constraints of use of the bearing and can therefore not be made optimum in order to ensure a seal. In particular, rapid wear either on the sealing lip or on the contact area is to be predicted, which limits the reliability of the sealing device. In addition, to enable the bearing to be assembled, the sealing device provided in the document EP-0 687 825 is relatively complex in shape and therefore difficult to produce at a cost compatible with current constraints in the automobile industry.

The invention therefore aims in particular to remedy these drawbacks by proposing a sealing device for a bearing with tapered rolling bodies which is reliable and can easily be produced, whilst not limiting the possibility of assembly of the said bearing.

To this end and according to a first aspect, the invention proposes a roller bearing of the type comprising an outer race and at least one inner race, the said races each comprising at least one oblique raceway for tapered rolling bodies disposed between them, in which an annular housing is provided between the said races in order to receive a sealing device for the bearing, in which the sealing device comprises a dynamic sealing joint associated with one of the races, the inside diameter of the joint being greater than or equal to the large diameter of the running surface of the raceway of the outer race, and an annular frame associated with the other race, the said frame comprising an annular housing in which the joint is disposed in order to rub against the said frame during the relative rotation of the races.

According to a second aspect, the invention proposes a method for assembling such a bearing, the said method comprising the steps making provision for:

mounting the rolling bodies on the inner race;

mounting the outer race provided in advance with the sealing joint on the inner race provided in advance with the frame.

According to a third aspect, the invention proposes a method for assembling such a bearing comprising an inner race in two parts on which there are respectively disposed a row of rolling bodies, the said method comprising the steps making provision for:

mounting the first row of rolling bodies on the first part of the inner race;

mounting the outer race provided in advance with the sealing joint on the first part of the inner race provided in advance with the frame;

mounting, in the outer race, the second part of the inner race provided in advance with the second row of rolling bodies.

Other objects and advantages of the invention will emerge during the following description, given with reference to the accompanying drawings, in which:

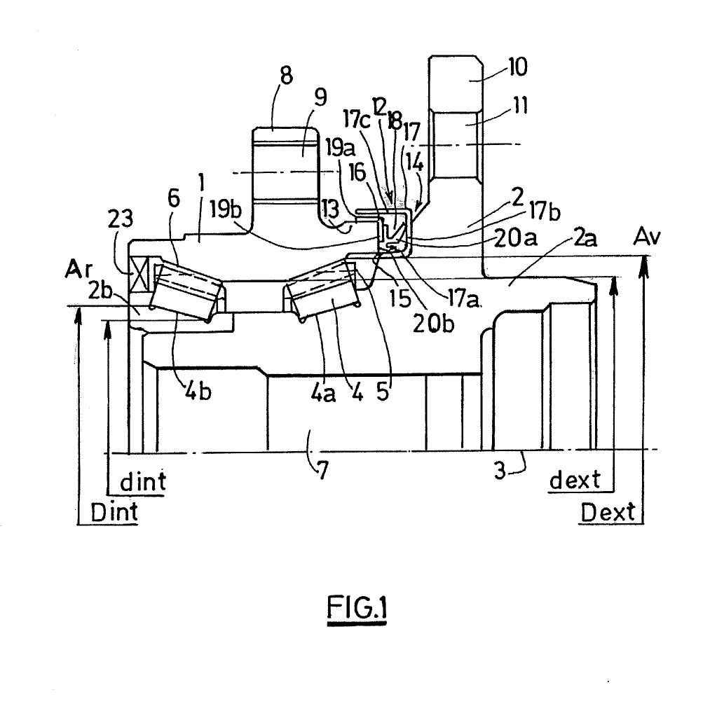

FIG. 1 is a partial view in longitudinal section of one embodiment of a bearing according to the invention;

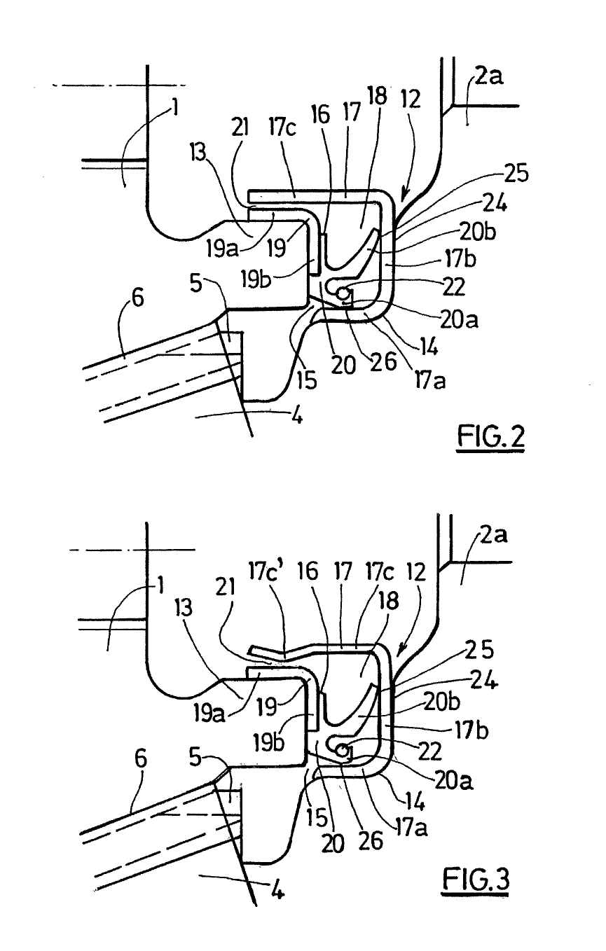

FIG. 2 is a partial view in longitudinal section of the sealing device equipping the bearing of FIG. 1;

FIGS. 3 to 7 are respectively a partial view in longitudinal section of a variant embodiment of a sealing device for a bearing with tapered rolling bodies according to the invention.

FIG. 1 depicts a roller bearing comprising a fixed outer race 1 and a rotating inner race 2. The inner race 2 is produced in two parts 2a, 2b, the second part 2b being mounted, for example by fitting in, in a housing provided in the first part 2a.

In order to provide the relative rotation about an axis 3 of the inner race 2 with respect to the outer race 1, two rows of tapered rolling bodies 4, kept at equal distances from each other by a cage 5, are provided between the said races. To this end, each race 1, 2 is provided with an oblique raceway 6 arranged to receive the rolling bodies 4 respectively between the first part 2a and the outer race 1 and between the second part 2b and the outer race 1.

However, the description given in relation to this embodiment can be directly transposed to a bearing in which the outer race is rotating and the inner race is fixed, or to a bearing comprising an inner race and a part on which the two raceways are produced.

In the description, the terms “outer” and “inner” are defined with respect to a plane respectively distant from and close to the axis 3, the terms “axial” or “transverse” are defined with respect to a plane parallel to the axis 3, the terms “radial” or “lateral” are defined with respect to a plane perpendicular to the axis 3, and the terms “front” and “rear” are defined with respect to the indices av and ar placed on FIG. 1.

To enable the bearing to withstand both axial and radial forces, the two rows of rolling bodies 4 are inclined with respect to the axis 3 and opposite each other. Thus the raceways 6 have annular running surfaces for the rolling bodies, the said surfaces having respectively a large diameter Dᵢₙₜ/Dₑₓₜ and a small diameter dᵢₙₜ, dₑₓₜ.

The bearing is in particular intended to be used for the rotation of a motor vehicle body with respect to the chassis of the said vehicle. To this end, the inner race 2 is provided with a bore 7 of axis 3 in which the hub or wheel axle can be disposed, for example by fitting in, and the outer race is associated with the vehicle chassis.

In the embodiment depicted in FIG. 1, the outer race 1 comprises a flange 8 for fixing the bearing to the chassis, the said flange 8 comprising fixing holes 9 arranged to allow association by bolting. Moreover, the inner race 2 comprises a flange 10 for fixing the bearing to a rotating structure, for example formed by the wheel rim, the said flange 10 comprising fixing holes 11 arranged so as to allow association by bolting.

The bearing also comprises, on the front side, an annular housing 12 provided between the first part 2a and the outer race 1. For this purpose, the outer race 1 comprises an axial extension 13 and the first part 2a comprises a housing 14 provided opposite the said extension 13. However, and to allow the relative rotation of the races 1, 2, an interstice 15 between the first part 2a and the outer race 1 is provided at the housing 12.

To prevent contamination of the inside of the bearing by external contaminants and to avoid spraying of lubricant outside the bearing, the invention proposes to dispose a sealing device in the housing 12 in order to cover the interstice 15.

In relation to FIGS. 1 and 2, a description is given below of an embodiment of a sealing device equipping a bearing according to the invention.

The sealing device comprises a dynamic sealing joint 16 associated with one of the races and an annular frame 17 associated with the other race. In the embodiment depicted, the joint 16 is associated with the axial extension 13 of the outer race 1 and the frame 17 is disposed in the housing 14 in the first part 2a. In one example embodiment, the sealing device is integrated by fitting in.

The frame 17, for example produced by pressing, comprises an internal axial fitting surface 17a, a radial wall 17b and an external axial surface 16c, which are arranged to form a housing 18 in which the joint 16 is disposed.

The joint 16 is formed by a frame 19, for example produced by pressing, comprising an axial fitting-in surface 19a and a radial wall 19b on which a sealing element 20 made from elastomeric material is moulded. The element 20 comprises a radial lip 20a and an axial lip 20b, the said lips being, during the relative rotation of the races 1, 2, in rubbing contact with the internal surfaces respectively of the internal surface 17a and of the wall 17b.

This design of the sealing device makes it possible, by using an attached frame 17 on which the lips 20a, 20b rub, to choose for the frame 17 a material resistant to the wear due to the rubbing contact and to the oxidation caused by the spraying of water and mud, without taking account of the mechanical stresses in use of the bearing since the frame 17 does not suffer the rolling stresses. In one particular example, the frame 17 can be produced from stainless steel.

In addition, the external surface 17c of the frame 17 can be designed to extend axially above the sealing joint 16 and beyond the wall 19b carrying the sealing element 20, so as to function as a deflector. This is because, by leaving a thin interstice 21 between the external surface 17c and the axial surface 19a, the possibility of access to the housing 18 for contaminants is particularly reduced thereby.

The sealing device thus provides a seal at three levels, namely the interstice 21, the axial contact between the axial lip 20b which rubs on the radial wall 17b and the radial contact between the radial lip 20a which rubs on the internal surface 17a.

In a variant, a spring 22 can be disposed in the radial lip 22a in order, by exerting an internal radial force on the lip 20a, to improve the contact between the said lip 20a and the internal surface 17a and therefore improve the seal still further.

According to a variant which is not shown, static sealing means can be integrated in the sealing device, for example in the form of elastomeric lips for sealing the respective fitting-in surfaces.

As depicted in FIG. 1, a conventional sealing means 23 can also be used, on the rear side, between the second part 20b and the external race 1.

In relation to FIGS. 3 to 7, a description is given below of the variant embodiments of the sealing device according to the invention.

The variant in FIG. 3 provides for the end part of the external surface 17c to comprise a part 17c′ offset axially inwards in order to improve the deflector function mentioned above.

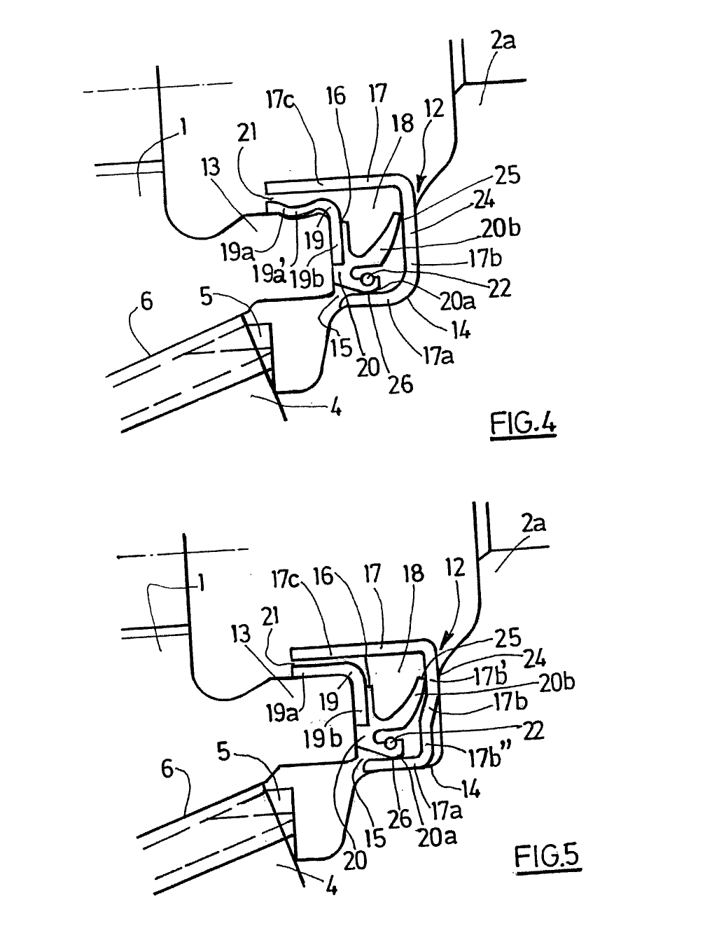

The variant in FIG. 4 provides for the axial surface 19a to comprise a part 19a′ offset axially inwards in order to improve the clamping force of the joint 17 on the outer race 1.

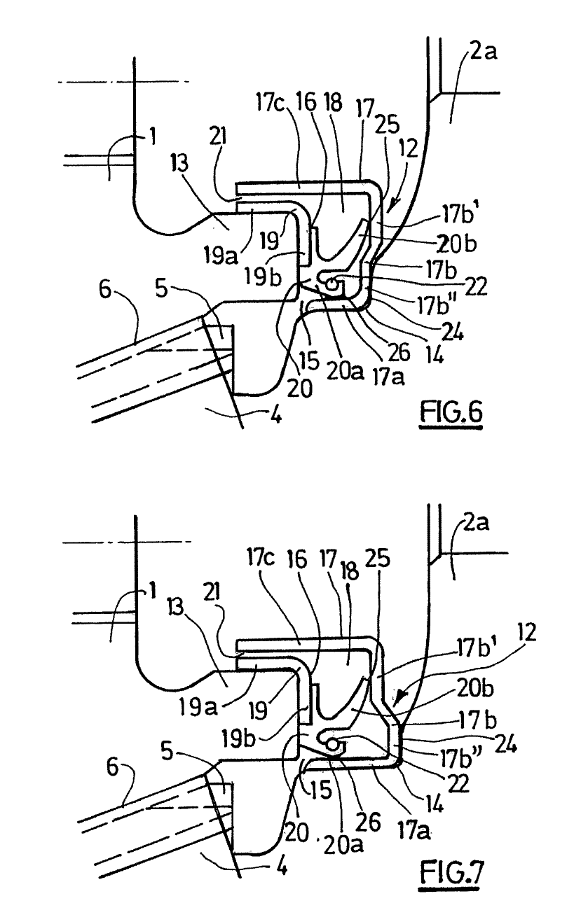

The variants in FIGS. 5 to 7 provide for the radial wall 17b of the frame 17 to comprise two parts 17b′, 17b″ offset axially with respect to each other. These designs make it possible, according to the geometry of the contact surface 24 between the housing 12 and the radial wall 17b, to adapt the geometry of the radial wall 17b in order to obtain optimum fixing. In addition, they make it possible, by offsetting, either towards the rear (FIGS. 5 and 6) or towards the front (FIG. 7), the contact surface 25 between the axial lip 20b and the radial wall 17b, to optimise this contact in order to improve the seal on the bearing.

A description is given below of the method for assembling a bearing according to the invention in which:

the rolling bodies 4 are mounted in the raceway 6 of the inner race 2;

the outer race 1 previously provided with the sealing joint 16 is mounted on the inner race 1 previously provided with the frame 17.

This method of assembly is made possible because the inside diameter of the joint 16, that is to say in the embodiment depicted the diameter of the radial lip 20a, is greater than or equal to the large diameter Dₑₓₜ of the running surface of the raceway 6 of the outer race 1. In an equivalent fashion, this condition can be expressed by stating that the diameter either of the internal axial surface 17a or of the annular contact surface 26 between the joint 16 and the internal axial surface 17a is greater than or equal to the large diameter Dₑₓₜ. It should also be noted that the diameter Dₑₓₜ is substantially equal to the largest external diameter of the row of rolling bodies 4 when the latter is mounted in the raceway 6 of the inner race 2.

This is because, at the time of assembly, the outer race 1 is moved from rear to front with respect to the inner race 2, and the joint 16 does not come into locking contact with the rolling bodies 4 disposed in the raceway 6 of the inner race 2, which allows the fitting of the outer race 1 on the inner race 2.

The method for assembling the bearing depicted in FIG. 1 comprises the steps making provision for:

mounting the first row 4a of rolling bodies 4 on the first part 2a of the inner race 2;

mounting the outer race 1 previously provided with the sealing joint 16 on the first part 2a of the inner race 2 previously provided with the frame 17;

mounting, in the outer race 1, the second part 2b of the inner race 2 previously provided with the second row 4b of rolling bodies 4.

1. A roller bearing of the type comprising an outer race (1) and at least one inner race (2), the said races each comprising at least one oblique raceway (6) for tapered rolling bodies (4) disposed between them, in which an annular housing (12) is provided between the said races in order to receive a sealing device for the bearing, the said bearing being characterised in that the sealing device comprises a dynamic sealing joint (16) associated with one of the races, the inside diameter of the joint (16) being greater than or equal to the large diameter (Dₑₓₜ) of the running surface of the raceway (6) of the outer race (1), and an annular frame (16) associated with the other race, the said frame (17) comprising an annular housing (18) in which the joint (17) is disposed so as to rub against the said frame during the relative rotation of the races (1, 2).

2. A bearing according to claim 1, characterised in that the frame (17) comprises an internal axial surface (17a), a radial wall (17b) and an external axial surface (17c) which are arranged so as to form the housing (18).

3. A bearing according to claim 2, characterised in that the joint (16) is formed by a frame (19) comprising an axial surface (19a) and a radial wall (19b) on which a sealing element (20) made from elastomeric material is moulded, the said element (20) comprising at least one radial lip (20a) in rubbing contact with the wall (17a) and at least one axial lip (20b) in rubbing contact with the internal surface (17b).

4. A bearing according to claim 3, characterised in that a spring (22) is disposed in the radial lip (20a) in order to improve the contact between the said lip and the internal surface (17a).

5. A bearing according to claim 3 or 4, characterised in that the external surface (17c) of the frame (17) extends axially above the sealing joint (16) and beyond the wall (19b) carrying the sealing element (20).

6. A bearing according to claim 5, characterised in that the end part of the external surface (17c) comprises a part (17c′) which is offset axially inwards.

7. A bearing according to any one of claims 3 to 6, characterised in that the axial surface (19a) comprises a part (19a′) which is offset axially inwards.

8. A bearing according to any one of claims 2 to 7, characterised in that the radial wall (17b) comprises two parts (17b′, 17b″) which are offset axially with respect to each other, the axial lip (20b) being in rubbing contact with one of these parts (17b′).

9. A method for assembling a bearing according to any one of claims 1 to 8, the said method comprising the steps making provision for:
mounting the rolling bodies (4) on the inner race (2);
mounting the outer race (1) previously provided with the sealing joint (16) on the inner race (2) previously provided with a frame (17).

10. A method for assembling a bearing according to any one of claims 1 to 8, the said bearing comprising an inner race (2) in two parts (2a, 2b) on which there are respectively disposed a row (4a, 4b) of rolling bodies (4), the said method comprising the steps making provision for:
mounting the first row (4a) of rolling bodies (4) on the first part (2a) of the inner race (2);
mounting the outer race (1) previously provided with the sealing joint (16) on the first part (2a) of the inner race (2) previously provided with the frame (17);
mounting, in the outer race (1), the second part (2b) of the inner race (2) previously provided with the second row (4b) of rolling bodies (4).
